(19) United States
(12) Patent Application Publication
(10) Pub. No.: US 2024/0206025 A1
(43) Pub. Date: Jun. 20, 2024

(54) FERRITE CORE AND INDUCTION COIL HAVING A FERRITE CORE FOR AN INDUCTIVE COOKTOP

(71) Applicant: GHSP, Inc., Holland, MI (US)

(72) Inventor: Benjamin Moes, Caledonia, MI (US)

(73) Assignee: GHSP, Inc., Holland, MI (US)

(21) Appl. No.: 18/538,013

(22) Filed: Dec. 13, 2023

Related U.S. Application Data
(60) Provisional application No. 63/387,629, filed on Dec. 15, 2022.

(51) Int. Cl. H05B 6/12

(52) U.S. Cl. CPC H05B 6/1254

(57) ABSTRACT

An inductive cooktop includes a transparent panel arranged to support a cookware object and an induction coil layer below the transparent panel. The induction coil layer includes a plurality of induction coils and a plurality of drivers in electronic communication with the induction coils. Each induction coil of the induction coil layer includes a ferrite core having a central portion circumscribed by windings of a conductor and a pair of end portions extending perpendicularly from the central point, the end portions bounding the conductor windings. The end portions of the ferrite core have a cross-section without corners, and may have radiused edges.

### CROSS-REFERENCE TO RELATED APPLICATIONS

This application claims benefit and priority under 35 U.S.C. § 119(e) of U.S. provisional application Ser. No. 63/387,629, filed Dec. 15, 2022, the contents of which are hereby incorporated herein by reference in its entirety.

### TECHNICAL FIELD

The present disclosure relates generally to an inductive cooktop system with a display, and more specifically to an induction coil having a ferrite core for an inductive cooktop system.

### BACKGROUND

Kitchens or other areas used to prepare and cook food may have an inductive cooktop, such as a cooktop that is part of a range unit or a separate cooktop unit that is placed on or installed directly in a countertop or other work surface. It is known that inductive cooktops can be used to effectively heat metal cookware that is capable of inductive coupling with a time varying electromagnetic (EM) field generated by one or a series of inductive coils comprising the cook top.

Conventional inductive coils may typically consist of a ferrite core structure around which is wound a conductor, typically a copper wire or the like. The ferrite core may include a central cylindrical or bar portion circumscribed by the conductor windings. The ferrite core may include end portions or members extending perpendicularly from the central portion circumscribed by the conductor windings. The end portions may assist in confining and directing the flux density of the time varying EM field in the direction of the cookware object disposed on the cook top.

Presently known measures for designing and constructing ferrite cores for inductive coils of an inductive cooktop can result in uneven flux distribution across the cooktop. Localized high peak intensity in EM flux can interfere with, for example, display signals in an LCD or OLED display disposed between the induction coils and a work surface of the inductive cooktop. Accordingly, there exists a need for improved inductive cooktops incorporating inductive coils having improved ferrite core designs that overcome the deficiencies of the conventional designs and that do not concentrate EM flux density into localized regions of high peak intensity.

### SUMMARY

The present disclosure provides an inductive cooktop system, an induction coil for a cooktop system, and a ferrite core for the induction coil. An inductive cooktop has a transparent panel configured to support a cookware object. The inductive cooktop includes a transparent panel configured to support a cookware object. The inductive cooktop includes an induction coil layer disposed below the transparent panel. The induction coil layer includes an induction coil. The induction coil includes a ferrite core, the ferrite core comprising a central portion, a first end portion adjacent the central portion and a second end portion adjacent the central portion opposite the central portion; and a conductor wound around the central portion of the ferrite core; wherein the first end portion and the second end portion extend perpendicular to the central portion and wherein the first end portion and the second end portion, respectively, have a rounded cross-section.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a perspective view of an example countertop with an inductive cooktop.

FIG. 2 is a perspective view of an example disc-shaped induction coil disposed below a pan resting on an inductive cooktop.

FIG. 3 is a schematic view of an example magnetic field generated by the induction coil shown in FIG. 2.

FIG. 4 is a schematic view of an example magnetic field generated by a U-shaped induction coil.

FIG. 5 is a schematic view of an example stack of layers corresponding to a portion of the inductive cooktop of FIG. 1.

FIG. 6 is a perspective schematic view of an example arrangement of induction coils for the inductive cooktop of FIG. 1.

FIG. 7 is a graphical plot of flux density from a top-down view of the arrangement of inductive coils shown in FIG. 6.

FIG. 8 is a perspective view of an inductive coil having a ferrite core.

FIG. 9 is a side view of the ferrite core of the inductive coil shown in FIG. 8 absent the conductor windings.

FIG. 10 is a schematic view of an example computing device that may be used to implement the systems and methods described herein.

FIG. 11 is a perspective schematic view of an arrangement of induction coils.

FIG. 12 is a graphical plot of flux density from a top-down view of the arrangement of inductive coils shown in FIG. 11.

Like reference symbols in the various drawings indicate like elements.

### DETAILED DESCRIPTION

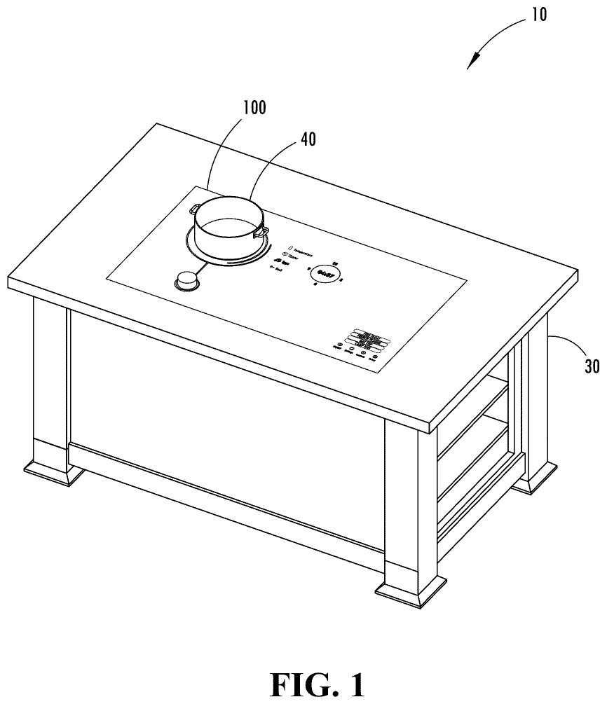

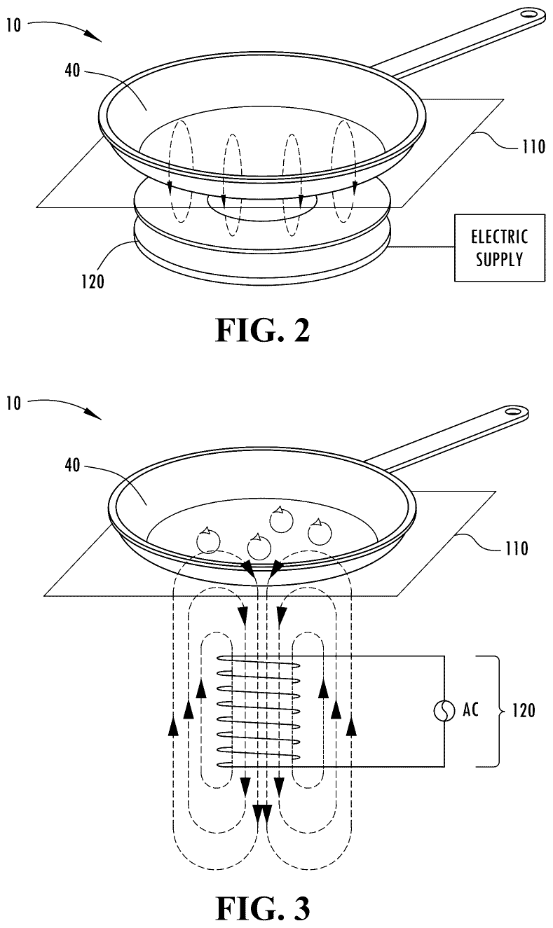

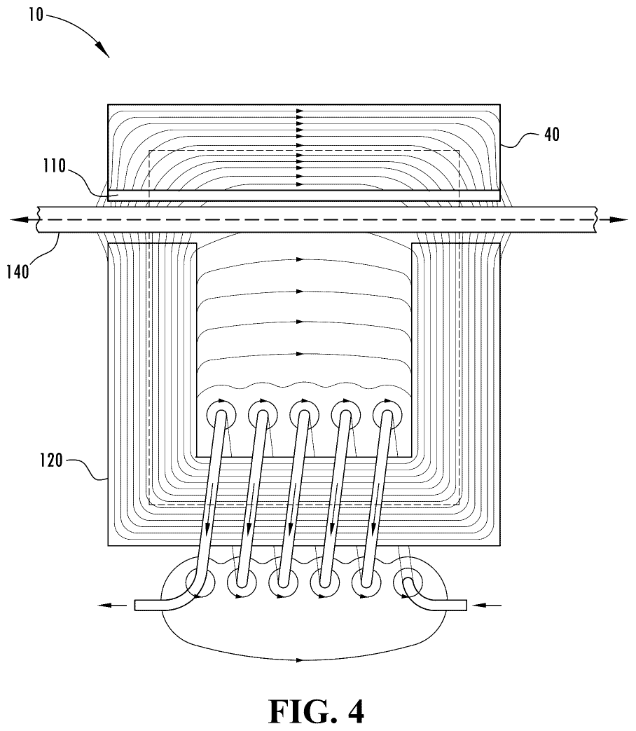

Referring to FIG. 1, an inductive cooktop 100 is provided in a kitchen environment 10 or other area used to prepare and cook food. For example, FIG. 1 illustrates the inductive cooktop system 100 installed in a countertop 20 of a cabinet 30 within the kitchen environment (e.g., a kitchen island). As shown in FIGS. 2 and 3, the inductive cooktop system 100 includes a top plate 110 (e.g., a transparent glass and/or ceramic panel) and an induction coil 120 (e.g., a solenoid coil) that is disposed below the top plate 110. Here, the induction coil 120 may refer to a solenoid coil of various shapes or configurations ranging from a C-shaped coil where each end of the “C” is adjacent to the top plate 110 (e.g., as shown in FIG. 4) to a more traditional pancake coil. The induction coil 120 may refer to a single coil or a plurality of coils (e.g., arranged in an inductive coil layer) below the top plate 110.

A power supply may supply alternating current, such as high-frequency or medium frequency current to the induction coil 120 to create a time varying electromagnetic (EM) field that can inductively couple with and heat a cookware object 40 e.g., a pan) supported on an upper surface of the top plate 110. The EM field may permeate through the upper surface of the top plate 110 in the area immediately above the induction coil 120, such as shown in FIGS. 2, 3, and 4. The EM field oscillates to create eddy currents in or near the bottom portion of the cookware object 40 that is supported on the top plate 110, such that the resistance of the cookware object 40 to the eddy currents causes resistive heating of the cookware object 40. Thus, the inductively heated cookware object 40 may heat and cook the contents within the cookware object 40. To adjust cooking settings, such as temperature, the power (e.g., via the current) supplied to the induction coil 120 may be adjusted.

The cookware object 40 may include a ferrous metal, such as at least at a base of the cookware object 40, to be capable of inductively coupling with the induction coil 120 and conductively spreading the heat to the cooking surface within the cookware object 40. The cookware object 40 may include various types of cooking vessels, such as a pot, a pan, an induction plate, a wok, and the like. It is also contemplated that the cookware object 40 may be product packaging, such as a metal food packaging that is configured to be used without an underlying piece of cookware. Further, it is contemplated that the other non-cookware objects may be used in place of the cookware object 40, such as an electrical or electronic device that is configured to inductively couple with the induction coil 120 to transfer data or power via the inductive coupling. Such an electrical device may include a kitchen appliance, such as a toaster or blender, a receptacle unit for plugging in other devices via electrical wires, or other personal electronic devices, such as cell phones. It should be understood that references herein to cookware object 40 includes non-cookware objects susceptible inductive coupling with the induction coil 120.

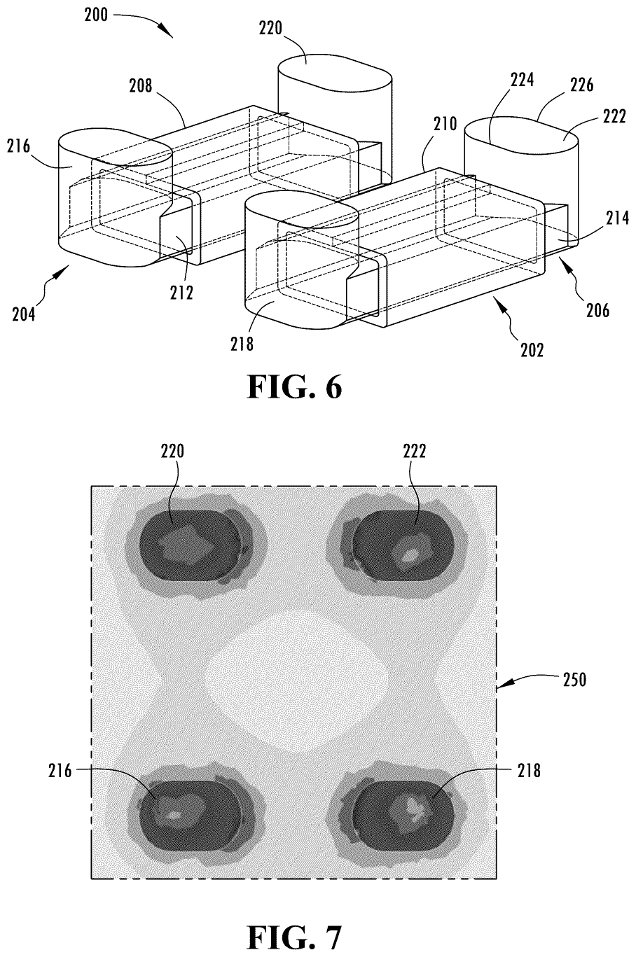

In some configurations, the system 100 includes a display element (e.g., shown as display panel 140), the configuration and/or construction of the coils 120 may aid in mitigating the coupling effects of the alternating EM field generated by the coil 120. In some examples, such as FIG. 4, the coil 120 is constructed as a U-core solenoid coil magnet to align the EM field line or flux in a given direction. Also, the induction coils in FIG. 6 include an arrangement of U-core induction coils 406 that are each positioned to align the EM fields in a common direction. By orienting the U-core solenoid coil magnet with a display element (e.g., display panel 140), metal or conductive lines in the display (e.g., the backplane of the display), which may be most vulnerable to electrical interference, are aligned parallel or generally parallel to the EM field lines. Additionally or alternatively, metal or conductive lines in the display that are identified as less vulnerable or least vulnerable to electrical interference may be aligned orthogonal to the EM field lines.

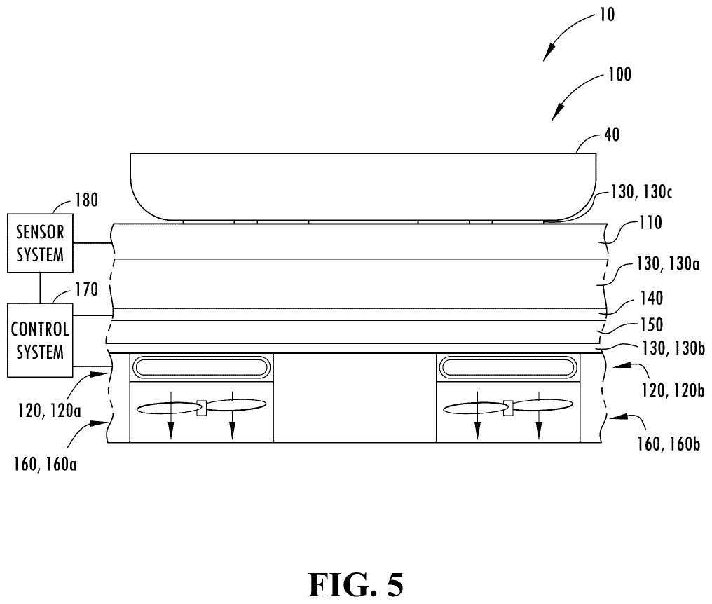

Referring to FIG. 5, the inductive cooktop system 100 may include one or more dissipation layers 130 and a display panel 140 between the cook top surface 110 and the induction coil 120 (also referred to as a coil layer 120). Here, a dissipation layer 130 may act as a thermal insulator such that heat generated by the coil layer 120, the display panel 140, and/or the cooktop surface 110 (e.g., via the cookware object 40) may be dissipated during operation of the cooktop system 100. This dissipation may help prevent malfunction and/or failure of different layers of the system 100, such as the display panel layer 140. A dissipation layer 130 may be a thermal insulating material or an air gap that allows air to flow between the layers. Here, in FIG. 5, the system 100 includes a first dissipation layer 130a between the cooktop surface 100 and the display panel 140, a second dissipation layer 130b between the display panel 140 and the coil layer 120, and a third dissipation layer 130c between the cookware object 40 and the cooktop surface 110. Although the system 100 illustrates three dissipation layers 130, 130a-c, the system 100 may include any number of dissipation layers 130. In some examples, in order to maintain the position of each layer, one or more layers of the system 100 may have structural standoffs. Additionally or alternatively, the system 100 or portions thereof may be fixed in position by a frame structure corresponding to the system 100.

Beneath the display panel 140, a support layer 150 (e.g., a glass support layer) provides a non-conducting support for the display panel 140. Below the support layer 150, a second dissipation layer 130b is shown separating the display panel 140 from the coil layer 120 (e.g., shown as two coils, 120, 120a-b). Beneath the coil layer 120, the system 100 may additionally include a cooling layer 160. For instance, each coil 120a-b includes a downdraft fan 160, 160a-b that functions to draw heat downward and away from the layers above the coil layer 120 (e.g., the display 140 or the cooktop surface 110). Additional or alternative cooling systems, such as heat sinks or liquid cooling, may be employed in additional examples to draw heat away from the coils.

The display panel 140 generally operates by coordinating the emission of light to generate graphics or other content information. For instance, based on this operation, a user perceives the emission of light as a display projected on the cooktop surface 110. Here, the display panel 140 is an organic light emitting diode (OLED) display panel that emits light using one or more OLEDs. In additional examples, the display panel may be a thin-film-transistor liquid crystal display (TFT LCD) panel, a light-emitting diode display (LED) panel, a plasma display panel (PDP) a liquid-crystal display (LCD) panel, a plasma display panel (PDP), or an electroluminescent display (ELD) panel. However, to use an OLED display panel 140 in conjunction with an induction coil layer 120, the system 100 needs to ensure that the OLED display panel 140 functions in particular operating conditions. For instance, the operation of the OLED display panel 140 may be diminished or compromised if the OLED display panel 140 is subjected to too much heat or too much electrical interference from a EM field associated with the coil layer 120.

In some examples, the inductive cooktop 100 includes a control system 170, such as control system circuitry, that is configured to detect or to receive inputs from a sensor system 180 and to perform processing tasks related to those inputs. In some configurations, the control system 170 is coupled to or in communication with the coil layer 120, the display 140, and/or the sensor system 180. For instance, the control system 170 may be physically wired to interfaces of these elements or communicate wirelessly with these elements. In some instances, the control system 170 includes or is in communications with drivers for operating the induction coils of the induction coil layer 120. The induction coil layer 120 is operable to generate a time varying electromagnetic field that inductively couples with the cookware object 40 supported on the inductive cooktop 100. With respect to the display panel 140, the control system 170 is configured to control the display panel 140, such as to display information at the cooktop surface 110, including at an area or areas of the upper surface that interfaces with a cookware object 40 that is inductively coupled with an induction coil 120. The control system 170 may control information displayed by the display panel 140 before, during, or after operation of the induction coil 120 inductively coupling with a cookware object 40. Some examples of information displayed by the display panel 140 include operational information of the cooktop, outlines of cooking zones or control interfaces, control interface images, media widows or information, or branding or advertising windows or information and other conceivable images and graphics. In some implementations, to control the display 140, the control system 170 is configured to control individual pixels of the display 140 by interfacing with and controlling voltage, current, and/or other signals to a pixel circuit.

In addition to controlling the display 140, the control system 170 is configured to control the coil layer 120. Here, the control system 170 may supply power (e.g., in the form of voltage or current), either directly or indirectly through one or more intermediate electronic devices, to one or more coils 120 of the coil layer 120, or one or more drivers in electronic communication with the one or more coils 120 to activate, deactivate, or adjust the characteristics of the coil 120 (e.g., adjust the heating power of one or more coils 120). In some configurations, the control system 170 includes more than one controller. Here, each controller may operate individually or communicate with each other to control some portion of the system 100. For instance, each of the display 140, the coil layer 120, and/or the sensor system 180 may include its own controller(s) that collectively form the control system 170. For example, different types of controllers may be used throughout the system 100 depending on the communication protocols required or the type of information/data that is being communicated.

FIG. 6 is a perspective schematic view of an example arrangement of induction coils 200, 202 for the inductive cooktop of FIG. 1. Each induction coil 200, 202, includes, respectively, a ferrite core 204, 206 and conductor windings 208, 210. The ferrite cores 204, 206 include, respectively, a central portion 212, 214 extending between a first end portion 216, 218 and a second end portion 220, 222 opposite the first end portion 216, 218. The conductor windings 208, 210 coil around a length of the central portion 212, 214. Although illustrated in FIG. 6 as an arrangement of two induction coils 200, the inductive coil layer 120 may comprise a matrix or array of induction coils including, for example, 20, 40, 100, or other number of induction coils.

In FIG. 6, the induction coils 200, 202 are illustrated as comprising a single, continuous conductor winding 208, 210 extending substantially the entire length of the central portion 212, 214 between the first end portion 216, 218 and the second end portion 220, 222. In other alternatives, multiple discrete conductor windings may extend along a common ferrite core. In such an alternative, the ferrite core may include interstitial portions similar separating adjacent conductor windings. The interstitial portions may extend from the central portion 212 similarly to the end portions 216, 220 so as to form a substantially E-shaped core. In some cases, adjacent induction coils may have parallel windings. In other alternatives, adjacent induction coils may have anti-parallel windings. Where adjacent coils have parallel windings, the adjacent coils may be driven in opposing phase to generate magnetic fields of opposite polarity or direction.

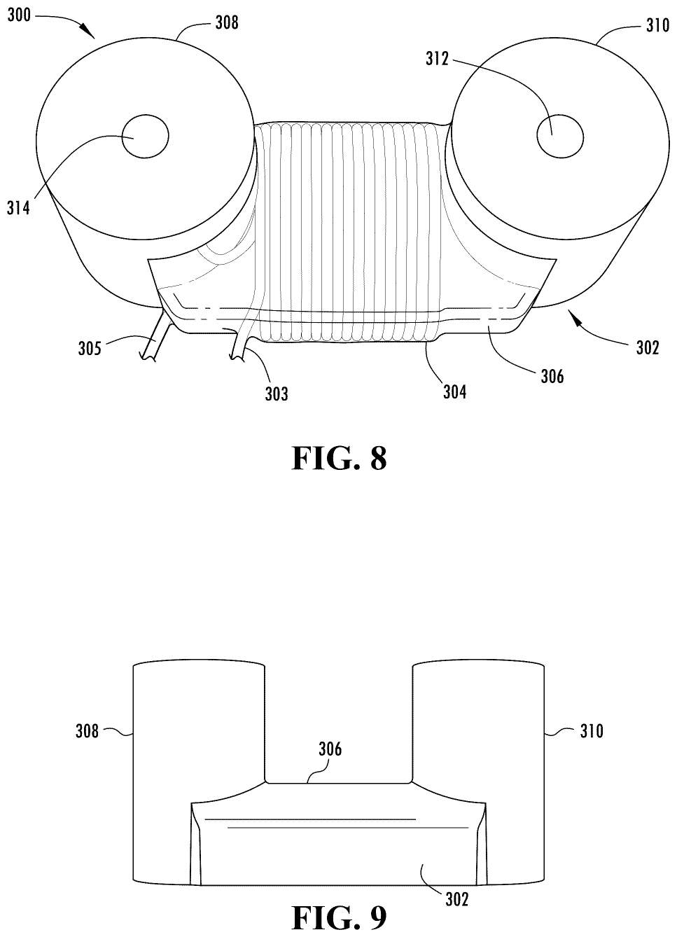

The ferrite core 204, 206 is illustrated where the central portion 212, 214 has a substantially rectangular cross-section along its length. This is not intended to be limiting and alternative cross-sectional shape may be suitable within the present scope. For example, the central portion 212, 214 may have a square, circular, oval, hourglass, or other suitable shape to provide an even distribution of EM flux through the cooktop surface. The ferrite core 204, 206 is illustrated where the first end portion 216, 218 and the second end portions 220, 222 have a pair of opposing flat faces 224, 226 connected by first and second curved or semi-circular ends, defining a rounded but not circular shape that corresponds to the rounded cross-section that is consistent along the lengths of each respective end portion. The ends of the central portion 212, 214 have an interfacing shape that mates with the sides of the first and second end portions, which is defined by the rounded non-circular cross-section thereof. In additional examples, the cross-section of the first end portion and second end portion may be circular, such as illustrated in the embodiment shown in FIGS. 8 and 9, as discussed below. Further, the side aspects of the first end portion and the second end portion may include flat portions between rounded edges. The cross-section of the first end portion and the second end portion of the ferrite core does not include angular vertices or adjacent straight faces so that the EM flux generated by the conductor windings will not concentrate in a discrete area or region of the ferrite core. Accordingly, additional examples include ferrite cores with rounded cross-sections at the first and second portions that have different, non-circular shaped cross-sections with various rounded shapes with different radii of curvature.

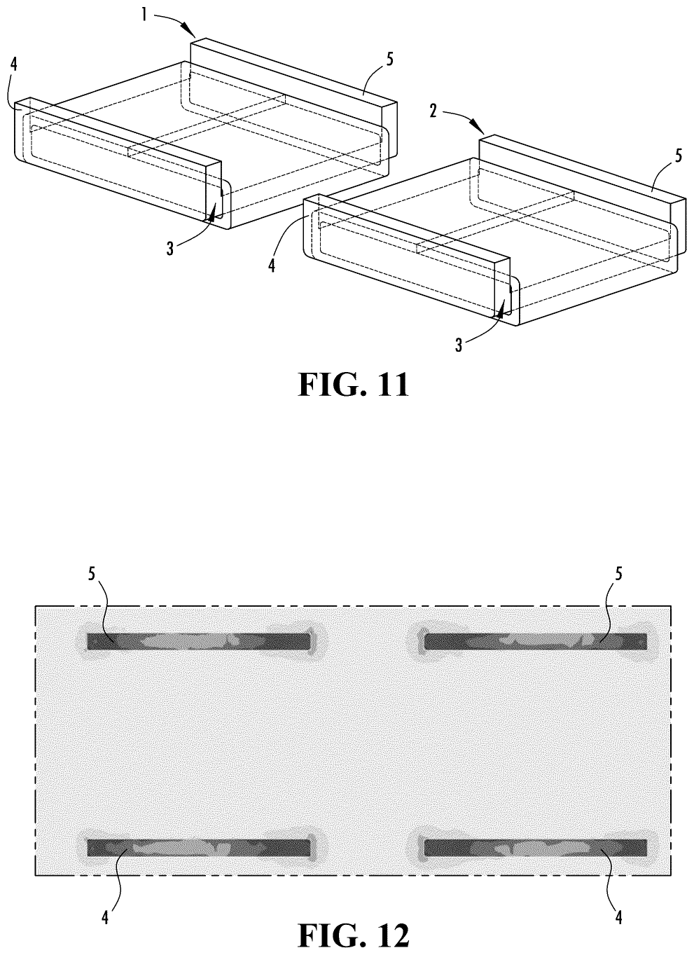

FIG. 7 is a graphical plot 250 of flux density from a top down view of the inductive coils 200, 202 as shown in FIG. 6, with higher magnitudes associated with darker shading. The plot 250 illustrates the distribution of EM field flux density measures in teslas (T) in the space surrounding the inductive coils 200, 202 and at the top face of the first end portion 216, 218 and the second end portion 220, 222. The highest values of flux density is at the perimeter of the first end portion 216, 218 and the second end portion 220, 222, of about 129 millitesla (mT). FIG. 11 illustrates a perspective schematic view of two induction coils 1, 2 aligned next to each other with a gap in between. Such induction coils may be known, for example, from commonly owned international patent application No. PCT/US2020/063425, published as WO 2021/113721 A1, the entirety of which is hereby incorporated by reference. The induction coils include a ferrite core having a central portion, which is a flat bar 3 bounded by end portions 4, 5 extending upwards. FIG. 12 illustrates a plot of flux density measured in the end portions 4, 5 from a top-down perspective of the coil arrangement shown in FIG. 11. The plot in FIG. 12 shows that the flux density is highly concentrated at the peripheral surface and particularly the corners of the end portions, 4, 5. A similar amount of magnetic power is being transmitted by the induction coils in preparing the measurement illustrated in FIG. 7 as with FIG. 12. In FIG. 12, the maximum concentration of flux density is again found at the perimeter of the end portions of the ferrite core, but with a value of about 300 mT. The end portions of the ferrite cores of the induction coils used to generate the plot in FIG. 12 includes sharp 90° corners between adjacent flat faces. This results in concentrating flux density rather than providing a more even distribution.

FIGS. 8 and 9 illustrate an implementation of an induction coil 300 having a ferrite core 302. FIG. 8 illustrates a perspective top down view of the induction coil 300 having the ferrite core 302 and conductor windings 304. The conductor windings 304 may include a first terminal 303 and a second terminal 305 to facilitate connection with the driver and control system arranged to electronically control the operation of the induction coil 300. The ferrite core 302 is illustrated from a side view and without the conductor windings in FIG. 9. The ferrite core 302 includes a central portion 306, a first end portion 308 and a second end portion 310. The central portion 306 is wider than the first and second end portions 308, 310. This is not intended to be limiting. For example, the central portion may be the same width as the first and second end portions, as illustrated in FIG. 6. In other alternatives, the central portion may be narrower than the first and second end portions.

As further shown in FIGS. 8 and 9, the first and second end portions 308, 310 have a rounded circular cross-section along their length extending perpendicularly from the central portion 306. The first and second end portions 308, 310 are formed with apertures 312, 314 extending partially or fully through the first and second end portions 308, 310, respectively. The apertures 312, 314 are illustrated as being disposed along a center of the circular cross-section of the first and second end portions 308, 310, but this is not intended to be limiting and the apertures 312, 314 may be offset from the center. The first and second end portions 308, 310 are illustrated as being cylindrical along their length extending beyond the central portion 306. The rounded shape is not limiting to a consistent cross section, as additional examples may have first and second end portions with varied cross-sectional shapes, such as being tapered along their lengths so as to have a frustoconical aspect. In some examples, the first and second end portions 306, 308 may be tapered to be narrower toward the central portion 306 than at an opposite end distant from the central portion 306. In further examples, the first and second end portions 306, 308 may be tapered to be wider toward the central portion 306 than at an opposite end distant from the central portion 306.

The dimensions and proportions of the illustrated examples shown in the FIGS. 6-9 are not intended to be the extent of dimensions or proportions for the inventive concepts embodied in the disclosed implementations. For example, the relative lengths of the central portion and first and second end portions, the relative height of the first and second end portions to the central portion, the relative widths of the first and second end portions to the central portion, and other illustrated aspects are not intended to be dimensionally or proportionally limiting for additional examples.

Throughout the Figures, the ferrite cores of the inductive coils are illustrated as being formed in one piece where the first and second end portion are integral with and extend directly from the central portion. This is not intended to be limiting and other alternatives are contemplated to be within the scope of the present disclosure. In one example, the central portion may be formed separately from the first end portion and the second end portion and thereafter assembled together using any suitable method known in the art. In another alternative, a first ferrite core may include central portion integral with a first end portion and arranged relative to a second ferrite core having a corresponding central portion and first end portion such that the first end portion of the second ferrite core constitutes a second end portion to the first ferrite core.

The disclosed arrangements illustrate scalable implementations to improve induction coil energy consumption efficiency, improve even distribution of induction EM field and decrease concentration of EM field flux to avoid interference with clock or data signals in adjacent electronics.

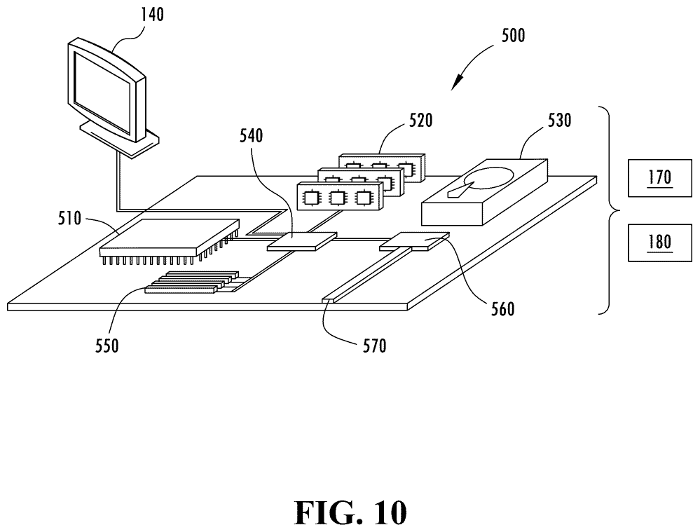

FIG. 10 is schematic view of an example computing device 500 that may be used to implement the systems (e.g., systems 100) and methods described in this document. The computing device 500 is intended to represent various forms of digital computers/processors, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510 (e.g., data processing hardware), memory 520 (e.g., memory hardware), a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common circuit board, such as a motherboard, or in other manners as appropriate. The processor 510 can process instructions for execution within the computing device 500, including instructions stored in the memory 520 or on the storage device 530 to display graphical information for a graphical user interface (GUI) on an external input/output device, such as display 140 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device (e.g., the display 140) or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. An inductive cooktop comprising:
a transparent panel configured to support a cookware object; and
an induction coil layer disposed below the transparent panel, the induction coil layer operable to generate a time varying electromagnetic field that inductively couples with the cookware object supported at the transparent panel; and
the induction coil layer comprising an induction coil;
the induction coil comprising a ferrite core, the ferrite core comprising a central portion, a first end portion adjacent the central portion and a second end portion adjacent the central portion opposite the first end portion; and a conductor wound around the central portion of the ferrite core; wherein the first end portion and the second end portion extend perpendicular to the central portion and wherein the first end portion and the second end portion, respectively, have a rounded non-circular cross-section.

2. The inductive cooktop of claim 1, wherein the rounded non-circular cross-section comprises a first semi-circular end, a second semi-circular end, and a part of flat faces separating the semi-circular ends.

3. The inductive cooktop of claim 2, wherein a first one of the pair of flat faces is disposed adjacent the conductor.

4. The inductive cooktop of claim 1, wherein the induction coil is a first induction coil, the induction coil layer further comprising a second induction coil, the second induction coil comprising a second ferrite core, the second ferrite core comprising a second central portion, a second first end portion adjacent the second central portion, and a second second end portion adjacent the second central portion opposite the second first end portion; and a second conductor wound around the second central portion of the second ferrite core; wherein the second first end portion and the second second end portion extend perpendicular to the second central portion; and wherein the second first end portion and the second second end portion, respectively have a second rounded cross-section.

5. The inductive cooktop of claim 4, wherein the second conductor is wound in an anti-parallel direction about the second central portion relative to conductor of the first induction coil.

6. The inductive cooktop of claim 4, wherein the rounded cross-section is a first rounded cross-section and wherein the second rounded cross-section is the same as the first rounded cross-section.

7. The inductive cooktop of claim 4, wherein the second induction coil is arranged in the induction coil layer such that the second central portion extends parallel to the first central portion.

8. An inductive cooktop comprising:
a transparent panel configured to support a cookware object; and
an induction coil layer disposed below the transparent panel, the induction coil layer operable to generate a time varying electromagnetic field that inductively couples with the cookware object supported at the transparent panel; and
the induction coil layer comprising an induction coil;
the induction coil comprising a ferrite core, the ferrite core comprising a central portion, a first end portion adjacent the central portion and a second end portion adjacent the central portion opposite the first end portion; and a conductor wound around the central portion of the ferrite core;
wherein the first end portion and the second end portion extend perpendicular to the central portion and wherein the first end portion and the second end portion, respectively, have a circular cross-section including a first aperture extending at least partially through the first end portion and a second aperture extending at least partially through the second end portion.

9. The inductive cooktop of claim 8, wherein the first aperture extends fully through the first end portion and the second aperture extends fully through the second end portion.

10. The inductive cooktop of claim 9, wherein the first aperture is disposed along a center of the circular cross-section of the first end portion and the second aperture is disposed along a center of the circular cross-section of the second end portion.

11. The inductive cooktop of claim 8, wherein the induction coil is a first induction coil, the induction coil layer further comprising a second induction coil, the second induction coil comprising a second ferrite core, the second ferrite core comprising a second central portion, a second first end portion adjacent the second central portion, and a second second end portion adjacent the second central portion opposite the second first end portion; and a second conductor wound around the second central portion of the second ferrite core; wherein the second first end portion and the second second end portion extend perpendicular to the second central portion; and wherein the second first end portion and the second second end portion, respectively have a second circular cross-section including a third aperture extending at least partially through the second first end portion and a fourth aperture extending at least partially through the second second end portion.

12. The inductive cooktop of claim 11, wherein the third aperture extends fully through the second first end portion and the fourth aperture extends fully through the second second end portion.

13. The inductive cooktop of claim 11, wherein the third aperture is disposed along a center of the circular cross-section of the second first end portion and the fourth aperture is disposed along a center of the circular cross-section of the second second end portion.

14. The inductive cooktop of claim 11, wherein the first induction coil and the second induction coil are arranged in the induction coil layer with the second central portion extending parallel to the first central portion.

15. The inductive cooktop of claim 14, wherein the second conductor is wound in an anti-parallel direction about the second central portion relative to conductor of the first induction coil.

16. The inductive cooktop of claim 11, wherein the circular cross-section is a first circular cross-section and wherein the second circular cross-section is the same as the first circular cross-section.

17. A ferrite core for an induction coil, the ferrite core comprising:
a central portion;
a first end portion adjacent the central portion; and
a second end portion adjacent the central portion opposite the first end portion;
wherein the first end portion and the second end portion extend perpendicular to the central portion and wherein the first end portion and the second end portion, respectively, have a cross-section selected from a rounded non-circular cross-section and a circular cross-section having an aperture extending at least partially along the first end portion and the second end portion respectively.

18. The ferrite core for an induction coil of claim 17, wherein the cross-section of the first end portion is a first cross-section, and wherein the cross-section of the second end portion is a second cross-section, and wherein the first cross-section is the same as the second cross-section.

19. The ferrite core for an induction coil of claim 17, wherein the cross-section is a consistent cross-section along the length of the first end portion and the second end portion, respectively.

20. The ferrite core for an induction coil of claim 17, wherein the central portion, the first end portion and the second end portion are formed integrally as a single unitary body.
